(19) United States
(12) Patent Application Publication
(10) Pub. No.: US 2022/0173648 A1
(43) Pub. Date: Jun. 2, 2022

(54) MECH-ELECT GENERATOR

(71) Applicant: Ronald Vang, Tucson, AZ (US)

(72) Inventor: Ronald Vang, Tucson, AZ (US)

(21) Appl. No.: 17/533,899

(22) Filed: Nov. 23, 2021

Related U.S. Application Data
(60) Provisional application No. 63/119,340, filed on Nov. 30, 2020.

(51) Int. Cl. H02K 53/00; H02K 7/02; H02K 7/18; H02K 11/00; H02K 11/21; H02K 11/30; F03G 3/08

(52) U.S. Cl. CPC H02K 53/00; H02K 7/02; H02K 7/1853; F03G 3/08; H02K 11/21; H02K 11/30; H02K 11/0094

(57) ABSTRACT

The present invention is the Mech-Elect Generator system that produces either AC or DC electricity on a 24 hour a day basis. The system has a Flywheel coupled to a generator to rotate together as one moving part and has two pairs of magnets; each pair has one electromagnet affixed to the frame and one permanent magnet attached to the Flywheel. The pairs of magnets are used to re-accelerate the device to operating speed after outside forces combine to slow the device. Magnetic Repulsion is the outside force used to bring the device back up to speed. The tapping system has an upper and a lower speed limit. Reaching the lower limit turns the tapping system on, while reaching the upper limit turns the tapping system off. Mech-Elect Generators can replace Wind Turbines, solar arrays, engines in Cars, Trucks, Boats and Ships, or provide electricity to remote locations; and more.

### CROSS-REFERENCES TO RELATED APPLICATIONS

This application is a non-provisional and claims benefit of U.S. Provisional Application No. 63/119,340 filed Nov. 30, 2020, the specification(s) of which is/are incorporated herein in their entirety by reference.

### BACKGROUND OF THE INVENTION

The world demand for electricity is going to keep growing, and energy is produced in many ways around the world, but all of them have drawbacks. For instance, hydro-electric plants connected with dams require huge volumes of water to be stored, then dropped through Penstock tubes to drive the massive generators, and this resource can only be used once per dam. Wind turbines require wind to spin the fans, but only up to a certain wind speed, then they must be shut down. Additionally, a lot of ground area is required to build wind farms, and when there is no wind, energy cannot be produced. Solar panels (without battery back-up systems) only produce power when the sun is shining, and solar farms also require a lot of space as each separate panel produces minimal power. Nuclear generators are relatively safe, but the storage and disposal of depleted Uranium is extremely expensive and will last forever, and nuclear reactor accidents have occurred. Generators that require burning fossil fuels (coal, natural gas, or petroleum) all have exhaust and byproducts that are released into the atmosphere, contributing to climate change issues. Also, there is no consistency of pricing for these fuels, making operating budgets difficult to maintain.

The continual growth in demand is not going to stop, and several solutions are being used at this time to try to meet this demand. For example, China is building more and more coal-fired plants, and they recently built the Three Gorges Dam that displaced many indigenous people. World-wide, more wind farms and solar arrays are being erected. Fossil fuel burning generating stations are scrubbing the air, which removes many of the pollutants, but cannot reduce the heat being generated at the same time. More nuclear power plants could be built, but government regulations make them cost-prohibitive, and there is still the issue of waste storage cost and location. Building new hydro-electric facilities has the same issues as nuclear power plants: huge costs and massive environmental regulations to overcome. Many municipalities have installed Waste-to-Energy plants that burn trash and recyclables to turn water into steam.

The goal of the electro-mechanical generator (herein referred to as “Mech-Elect Generator”) is to produce DC current (and electricity) on a 24 hour a day basis. The generator will also be able to produce alternating current (AC) as well as DC. The generator comprises a base plate, a vertical frame support, a drive shaft, a flywheel, a first ball bearing and a second ball bearing to support the drive shaft and the flywheel, a generator, a mounting block for the generator, an electrical package for the system, and a hex nut attached to the first end of the drive shaft for the start-up procedure of the generator. Two electromagnets are attached to the vertical frame on either side of the flywheel. The magnets and the electromagnets are oriented such that the same poles are facing each other to generate a repulsive push that accelerates the flywheel and the device back up to operating speed.

The Mech-Elect Generator is significantly less costly to manufacture and install. The compact nature of the Mech-Elect Generator (as a replacement for wind farms and solar arrays) results in far less space being required to generate an equivalent amount of power. The minimal environmental impact would negate many of the design requirements and government regulations that bog down new power plant construction projects. The lower environmental requirements allow for construction of Mech-Elect Generators much closer to towns and cities, thus reducing the need for new or upgraded power lines in the grid. Additionally, the reduced requirement for fossil fuel burning power plants and all the internal combustion powered vehicles will help reduce the effects of climate change.

### BRIEF SUMMARY OF THE INVENTION

It is an objective of the present invention to provide systems that allow for generating electricity with the Mech-Elect Generator, as specified in the independent claims. Embodiments of the invention are given in the dependent claims. Embodiments of the present invention can be freely combined with each other if they are not mutually exclusive.

The present invention is a mech-elect generator that produces electricity on a 24 hour a day basis. The Mech-Elect Generator features a flywheel coupled to the drive shaft of a DC generator to rotate together as a one moving part. The heart of the device are two pairs of magnets (one permanent magnet paired with an electromagnet) that utilize magnetic repulsion to re-accelerate the device back up to operating speed when other outside forces have slowed the speed of rotation. The Mech-Elect Generator reacts as it should to the effect of all the outside forces. Virtually all these forces act to slow the speed of rotation. To counteract these forces, magnetic repulsion is the outside force used to bring the system back up to operating speed. It may take 3 or 4 seconds for the speed to drop 100 rpms, but it only takes 1/1000^{th} of a second to bring it back up to speed. The system does this with a tapping system that consists of a speed measuring device, a small LED light, two pieces of reflecting tape or mirrors, a photo-sensor switch and the two pairs of magnets. When the speed drops to the lower limit, the LED light comes on and shines on the edge of the flywheel. The instant the LED light beam hits one of the two pieces of reflecting tape, it activates the photo-sensor switch and energizes the two electromagnets. The current through the electromagnets causes instantaneous magnetic reactions (repulsions) in each pair of magnets. The electromagnets are fixed and cannot move, but the permanent magnets are already rotating in the proper direction, so they move the entire flywheel away from the electromagnets. As soon as the light beam passes the first end of the reflecting tape, the magnets are turned off. If the desired operating speed is achieved, the LED light is turned off. If the system does not reach operating speed, and because the light is still turned on, it will reach the next piece of reflecting tape in less than one revolution, and the electromagnets will be turned on again for 1/1000^{th} of a second, which will bring it back up to operating speed.

The Mech-Elect Generator can be used to replace home solar arrays, retro-fit Wind Turbines to sit on the ground and improve efficiency by 30% or more, power vehicles from commuter cars to over the road semis, power boats and ships, provide remote power for people far from the power grid, and so much more.

One of the unique and inventive technical features of the present invention is the set of magnets that are attached to the flywheel and the electromagnets that are on either side of the flywheel on the vertical frame support. Without wishing to limit the invention to any theory or mechanism, it is believed that this technical feature of the present invention advantageously provides for a method to keep the Mech-Elect Generator running. For example, the magnets and the electromagnets are positioned such that the same poles are facing one another, causing the flywheel to accelerate back up to operating speed. 99.999% of the time, the rotation of the device is accomplished by the inertia of the rotating flywheel. Furthermore, the Mech-Elect Generator has a speed-measuring device coupled to an LED light and a photo-sensor switch. The speed measuring device detects when the flywheel is rotating below a certain speed and will turn on the LED light. The light will be reflected off reflective material attached to the flywheel (180° apart) and will be reflected to the photosensor. The photo-sensor turns on a switch that allows current to flow to the electromagnets, bringing the device back up to operating speed in 1/1000^{th} of a second. None of the presently known prior references or work has the unique inventive technical feature of the present invention.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1 shows a simplified sketch of the layout of the Mech-Elect Generator.

FIG. 2 shows a basic layout of the circuitry of the electromechanical generator and the configuration for the placement of the electromagnets, the LED light, and the photo-sensor switch in relation to the flywheel.

FIGS. 3A-3B are different views of one embodiment of the flywheel, with the large gray disk representing the end view of the flywheel from the generator end of the device. FIGS. 3A-3B show the preferred placement of the first and second permanent magnet and the reflective material on the flywheel and the preferred placement of the electromagnet.

### DETAILED DESCRIPTION OF THE INVENTION

Following is a list of elements corresponding to a particular element referred to herein:

100 Mech-Elect Generator system

110 base plate

120 vertical frame support

122 vertical frame support first arm

124 vertical frame support second arm

130 drive shaft

132 first ball bearing

134 second ball bearing

140 flywheel

142 first permanent magnet

144 second permanent magnet

146 first reflective material

148 second reflective material

150 generator

152 first electromagnet

154 second electromagnet

160 mounting block

170 tapping system

172 speed measuring device

174 photo-sensor switch

176 LED light

180 hex nut

190 electrical package

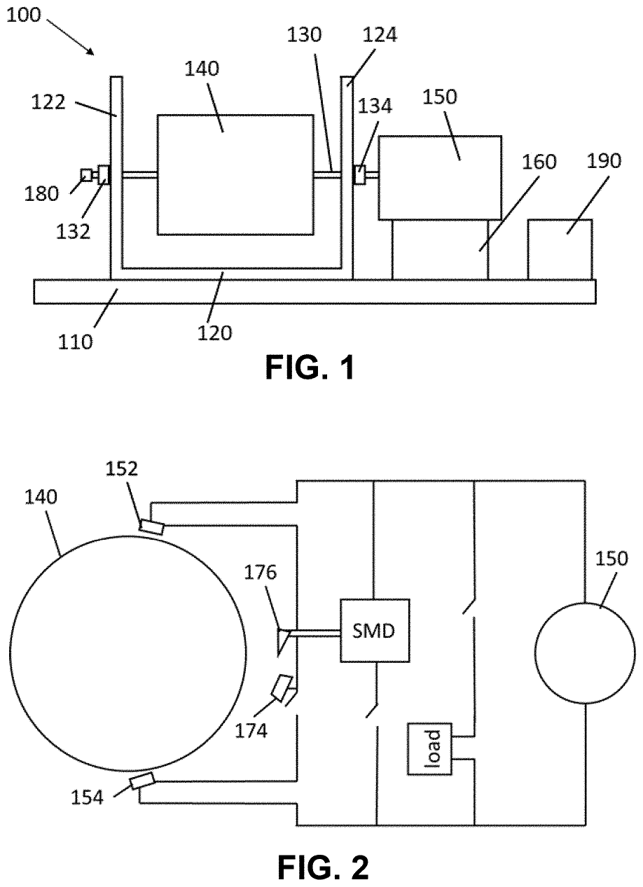

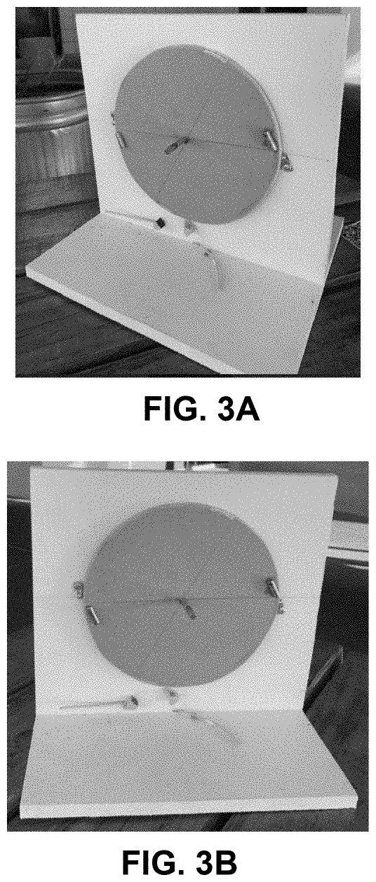

Referring to FIGS. 1-2, in some embodiments, the present invention features a mech-elect generator system comprising a base plate, vertical frame supports, a drive shaft, a flywheel, an AC or DC generator, a hex nut, an electrical package, and a tapping system. In preferred embodiments, the vertical frame support is disposed on the base plate and comprises a first arm and a second arm. The drive shaft is centrally disposed in the vertical frame support, a first end of the drive shaft is attached to the first arm of the vertical frame support via a first ball bearing, and a second end of the drive shaft is attached to the second arm of the vertical frame support via a second ball bearing. The flywheel is disposed on the drive shaft between the first arm and second arm of the vertical frame support.

In some embodiments, a first permanent magnet and a second permanent magnet are affixed to an edge of the flywheel and diametrically opposed to each other. The first permanent magnet and the second permanent magnet have the same poles facing the edge of the flywheel. In other embodiments, a first reflective material and a second reflective material are disposed adjacent to the edge of the flywheel and perpendicular to the first permanent magnet and the second permanent magnet. In other embodiments, the generator is operatively coupled to the drive shaft. The generator is disposed on a hard rubber mounting block to prevent unneeded vibrations, and the hard rubber mounting block is disposed on the base plate.

In preferred embodiments, the tapping system comprises a speed measuring device, a first electromagnet, a second electromagnet, a photo-sensor switch, and an LED light. The first electromagnet is located 180° away from the second electromagnet, and both electromagnets are adjacent to the edge of the flywheel and oriented such that the same pole type is facing the first permanent magnet and the second permanent magnet and are pointing in the direction of rotation of the system.

In some embodiments, a hex nut is attached to the first end of the drive shaft and is only used in initial start-up of the system. The LED light is operatively coupled to the first electromagnet and the second electromagnet via a photo-sensor switch, and the LED light is operatively coupled to the speed measuring device. In preferred embodiments, the LED light is turned on when the speed of rotation is equal to or less than 3000 rpms, and the LED light is turned off when the speed of rotation is equal to or greater than 3100 rpms. In other embodiments, the electrical package is disposed on the base plate and comprises circuitry for controlling an output voltage, and the electrical package splits the output of the generator to go to a load and to the tapping system.

In some embodiments, to start the operation of the Mech-Elect Generator system, the flywheel is manually rotated via the hex nut up to bring the system to 1300-1500 rpms when the tapping system is shut off. Upon turning the tapping system on, the speed measuring device measures the speed of the flywheel and turns on the LED light if the rpm is less than 3000 rpms, the LED light beam reflects off of the first reflective material it comes to, and the light is reflected to the photo-sensor switch, which allows current to flow to the first electromagnet and second electromagnet, causing the first permanent magnet and second permanent magnet to repel away from the first electromagnet and the second electromagnet to bring the system back up to operating speed by using inertia of the flywheel and the drive shaft and to generate power and drive the generator. For example, if it takes 3 seconds for the system to slow by 100 rpms and 1/1000^{th} of a second to speed back up, the system is operating off inertia for 99.996% of the time, and off magnetic repulsion for 0.0333% of the time.

In preferred embodiments, to begin the operation of the system, the tapping system is turned off completely. Using a drill motor with a socket driver, on the hex nut affixed end of the drive shaft, the single moving part of the generator system is gradually brought up to the maximum available speed of the drill motor, for example, a speed of about 1500 rpms. Once the socket is removed from the hex nut at the end of the drive shaft, the Tapping System is turned on. At a speed of about 1500 rpms, electricity is now being generated in the system. Turning on the tapping system allows the speed measuring device to determine that the speed is below the lower limit of 3000 rpms and the LED light is immediately turned on. When the light is on, the light will reflect off of one of the two pieces of reflective material which energizes the electromagnets, pushing the rotating permanent magnets away from the fixed electromagnets. This will repeat once every half revolution until the set upper limit is reached.

In other embodiments, once the speed measuring device detects the speed is greater than or equal to 3100 rpms, it will shut off the LED light which cuts off the tapping system until the speed once again drops below 3000 rpms. In further embodiments, the flywheel is always rotating in one direction. When the tapping system is energized to bring the flywheel back up to operating speed, the repulsive push is in the same direction it is already rotating; there is never any change in the direction of rotation.

In one embodiment, the first permanent magnet and the second permanent magnet are permanent neodymium magnets. In other embodiments, the first permanent magnet and the second permanent magnet each have a force of about 5 pounds. In some embodiments, the first electromagnet and the second electromagnet each produce a force of about ½ a pound when energized.

In some embodiments, the first reflective material and the second reflective material is reflective tape or a mirrored surface. In further embodiments, the first reflective material and the second reflective material each cover an arc of about 5% of the circumference of the flywheel, or 18° of an arc. As a non-limiting example, for a 20″ circumference flywheel, the reflective material will cover an arc of about 1-inch.

In other embodiments, the speed measuring device measures the speed of rotation of the flywheel by counting the number of rotations per minute or by measuring the power output of the generator. In some embodiments, the generator is a direct current (DC) generator and generates DC. In other embodiments, the generator also generates alternating current (AC) power as well as DC.

In some embodiments, the drive shaft and the flywheel are two separate pieces connected with a connecting piece or coupling. In other embodiments, the generator is coupled to an extended length drive shaft and no coupling or connecting piece is required and the flywheel is mounted directly on the drive shaft. In other embodiments, the drive shaft is connected to the vertical frame support using one ball bearing. In some embodiments, the vertical frame support is triangular or rectangular. In other embodiments, the system can be used to build new power plants, in retro-fitting wind turbines to sit on the ground, to replace inefficient solar arrays, or to power commuter vehicles or marine craft, or to provide remote power wherever needed.

### EXAMPLE

The following is a non-limiting example of the present invention. It is to be understood that said example is not intended to limit the present invention in any way. Equivalents or substitutes are within the scope of the present invention.

The model of the Mech-Elect generator uses a small DC generator and a 20″ circumference flywheel. The goal is to produce DC current and electricity on a 24 hour a day basis. If the device is rated at 5 kw, the device will produce approximately 5.5 kw. The output will fluctuate between 5.1 and 5.5 kw as it slows down and speeds back up again, but it will always produce the 5 kw it is rated at.

The flywheel is attached to the drive shaft of the generator in one of two ways. On small units, small generators with extended-length drive shafts can be used so there is no need to connect the two pieces together. On larger units where long drive shafts are not as practical, the drive shaft supporting the flywheel and the drive shaft from the DC generator would need to be connected with a connecting coupler. The weight of the flywheel needs to be supported with a vertical frame support. The vertical frame support can be triangular or rectangular depending on the application.

The drive shaft is supported on the vertical frame support with at least one ball bearing at the first end of the drive shaft which allows the drive shaft to rotate freely, reducing the friction as much as possible. On small units with short drive shafts, one ball bearing at the end of the drive shaft farthest away from the generator can be used to support the drive shaft. On larger units, there is a need for two ball bearings to be used, one at either end of the flywheel.

Two electromagnets are attached to the vertical frame support on either side of the flywheel. When energized, each electromagnet produces approximately ½ a pound of force. Two neodymium magnets are attached near the edges of the flywheel on opposite sides of the flywheel. Each magnet has a force of about 5 pounds. Two strips of highly reflective tape are also attached to the sides of the flywheel and are placed on opposite sides of the flywheel, located to coordinate when each of the already rotating permanent magnets has passed the fixed electromagnets.

The Tapping System of the Mech-Elect Generator comprises a speed measuring device that constantly measures the speed of rotation by either counting the rotations or by measuring the power output being produced. Built into the tapping system is a lower speed limit and an upper speed limit. The lower limit is the trigger that turns on the tapping system, and the upper limit shuts off the tapping system.

If the speed of the flywheel is less than or equal to 3000 rpms, it will turn on an LED light that is focused on the flywheel. This light will stay illuminated until the speed of the flywheel is greater than or equal to 3100 rpms. If the light is on, that means the speed is still under 3100 rpms. When the light reflects off the reflective tape it will hit a photo-sensor switch. This switch will only stay closed while the light is reflected onto the photo-sensor.

The magnets and the electromagnets are all set so they have the same poles pointing at each other. The electromagnets are fixed to the support frame so they cannot move. The permanent magnets attached to the flywheel are already moving, so when the electromagnets are energized, the permanent magnets are instantly repelled away from the fixed electromagnets because the magnets are set with like poles in alignment. This repulsive force re-accelerates the flywheel. As soon as the speed of the flywheel is equal to or greater than 3100 rpms, the light shuts off and the unit begins to slow down again.

To start the Mech-Elect Generator, the flywheel needs to be spinning in order to produce power. With the tapping system shut off, a drill motor can be attached to the end of the drive shaft via the hex nut and the flywheel is rotated up to about 1300-1500 rpms. The drill motor is then removed from the drive shaft hex nut, the tapping system is turned on, and the speed measuring device will measure that the flywheel is below 3000 rpms and will turn on the LED light, causing the electromagnets to be energized twice per revolution, every time there is proper alignment of the four magnets.

As used herein, the term “about” refers to plus or minus 10% of the referenced number. Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A mech-elect generator system (100), said system comprising:
a. a base plate (110);
b. a vertical frame support (120) disposed on the base plate (110), wherein the vertical frame support (120) comprises a first arm (122) and a second arm (124);
c. a flywheel (140) having a first permanent magnet (142) and a second permanent magnet (144) fixedly disposed adjacent to an edge of the flywheel and diametrically opposed to each other, wherein the first permanent magnet (142) and the second permanent magnet (144) have the same poles facing the edge of the flywheel, wherein a first reflective material (146) and a second reflective material (148) are disposed adjacent to the edge of the flywheel and perpendicular to the first permanent magnet and the second permanent magnet;
d. a drive shaft (130) centrally disposed through the flywheel (140) and rotatably coupled to the vertical frame support, wherein a first ball bearing (132) attaches a first end of the drive shaft to the first arm of the vertical frame support and a second ball bearing (134) attaches a second end of the drive shaft to the second arm of the vertical frame support such that the flywheel (140) is disposed between the first arm (122) and a second arm (124);
e. an AC or DC generator (150) operatively coupled to the drive shaft, wherein the generator is disposed on a hard rubber mounting block (160), wherein the hard rubber mounting block is disposed on the base plate (110);
f. a hex nut (180) attached to the first end of the drive shaft (130), wherein the hex nut (180) is only used in initial start-up;
g. an electrical package (190) disposed on the base plate (110), the electrical package comprising circuitry for controlling an output voltage, wherein the electrical package (190) splits the output voltage to go to a load and to a tapping system (170); and
h. the tapping system (170), the tapping system (170) comprising:
i. a speed measuring device (172);
ii. a first electromagnet (152) and a second electromagnet (154) disposed on the second arm (124) of the vertical frame support such that the first electromagnet (152) is located 180° from the second electromagnet (154), wherein both electromagnets are adjacent to the edge of the flywheel and oriented such that the same pole type is facing the first permanent magnet (142) and the second permanent magnet (144) on the flywheel;
iii. a photo-sensor switch (174), wherein the photo-sensor switch is electrically coupled to the first electromagnet and the second electromagnet via a switch which is only closed when light is reflected onto the photo-sensor switch; and
iv. an LED light (176) operatively coupled to the speed measuring device and the photo-sensor switch, wherein the LED light is shut off when the speed of rotation reaches an upper limit equal to or greater than about 3100 rpms and is turned on when the speed of rotation reaches a lower limit equal to or less than about 3000 rpms;
wherein to start initial operation of the mech-elect generator system (100), the flywheel (140) and generator (150) are manually rotated using a drill motor on the hex nut (180) connected to the first end of the drive shaft to bring them both up to about 1300-1500 rpms while the tapping system (170) is shut off, wherein once the drill motor is disconnected from the hex nut, the Tapping System (170) is turned on, wherein the speed measuring device (172) measures the speed of the flywheel (140) and generator (150) and because the speed is still less than 3000 rpms, the speed measuring device (172) turns on the LED light (176), wherein the LED light (176) reflects off the first reflective material (146) onto the photo-sensor switch (174), closing the switch that allows current to flow to the first electromagnet (152) and the second electromagnet (154) which instantly repels the rotating first permanent magnet (142) and the rotating second permanent magnet (144), wherein repulsion between the permanent magnets and the electromagnets brings the entire system back to operating speed, wherein when the speed measuring device (172) recognizes that the speed is equal to or greater than the upper limit of about 3100 rpms, it shuts off the LED light (176) until a next time the system speed drops to less than or equal to 3000 rpms.

2. The system of claim 1, wherein the first permanent magnet (142) and the second permanent magnet (144) are neodymium magnets.

3. The system of claim 1, wherein the first permanent magnet (142) and the second permanent magnet (144) each have a force of about 5 pounds.

4. The system of claim 1, wherein the first electromagnet (152) and the second electromagnet (154) each produce a force of about ½ a pound when energized.

5. The system of claim 1, wherein the first reflective material (146) and the second reflective material (148) are reflective tape or a mirrored surface.

6. The system of claim 1, wherein the first reflective material (146) and the second reflective material (148) each cover an arc of about 5% of a circumference of the flywheel, or about 18 degrees of an arc.

7. The system of claim 1, wherein the speed measuring device (172) measures the speed of rotation of the flywheel by counting the number of revolutions per minute or by measuring the power output of the generator.

8. The system of claim 1, wherein the system generates direct current (DC) or alternating current (AC).

9. The system of claim 1, wherein the drive shaft (130) and the flywheel (140) are two separate pieces connected with a connecting piece.

10. The system of claim 1, wherein the drive shaft (130) is connected to the vertical frame support (120) using two ball bearings.

11. The system of claim 1, wherein the vertical frame support (120) is triangular or rectangular.

12. The system of claim 1, wherein the system is used to replace home solar arrays, to retro-fit wind turbines to sit on the ground, to power vehicles, to power boats and ships, or to provide remote power for people far from the power grid.
